(19) United States
(12) Patent Application Publication
(10) Pub. No.: US 2002/0031178 A1
(43) Pub. Date: Mar. 14, 2002

(54) Video encoding method and apparatus, recording medium, and video transmission method

(75) Inventor: Masaaki Isozaki, Kanagawa (JP)

Correspondence Address: FROMMER LAWRENCE & HAUG, LLP., 10TH FLOOR, 745 FIFTH AVENUE, NEW YORK, NY, 10151, US

(73) Assignee: SONY CORPORATION

(21) Appl. No.: 09/950,764

(22) Filed: Sep. 12, 2001

Related U.S. Application Data
(63) Continuation of application No. 09/073,595, filed on May 6, 1998.

(30) Foreign Application Priority Data
Jun. 2, 1997 (JP) 09-144306

(51) Int. Cl. H04N 7/12

(52) U.S. Cl. 375/240.12; 375/240.01; 375/240.24; 375/240.15

(57) ABSTRACT

As the human visual sensitivity is high for a dark portion, a noise contained in a dark moving picture is easily perceived. There is a problem that a noise is prominent unless a bit rate is sufficient for a dark fade-in/fade-out point.

A bit assignment calculation block 22, under control of an MPEG encoder controller 23, detects an interval of bright/dark change via a dark portion such as a fade-in/fade-out interval according to a level and temporal change of an average luminance in a frame of a video material and corrects a coding difficulty which represents an image complexity, in this interval by multiplying the difficulty by a weighting coefficient, so that the entire bit rate is assigned according to the corrected coding difficulty.

### BACKGROUND OF THE INVENTION

1. Field of the Invention

The present invention relates to a video encoding method and apparatus, a recording medium, and a video transmission method for coding an image according to an image frame coding difficulty.

2. Description of the Prior Art

When storing a video information on a package medium such as a digital video disc (DVD) and a video CD, an encoding system for carrying out a compression coding to the video information firstly determines a coding difficulty of a material image and according to this coding difficulty, carries out bit assignment for each of the video information frames so that the entire video information is stored in a given number of bytes of the package medium as a recording capacity. Hereinafter, this encoding method will be referred to as two-path encoding method.

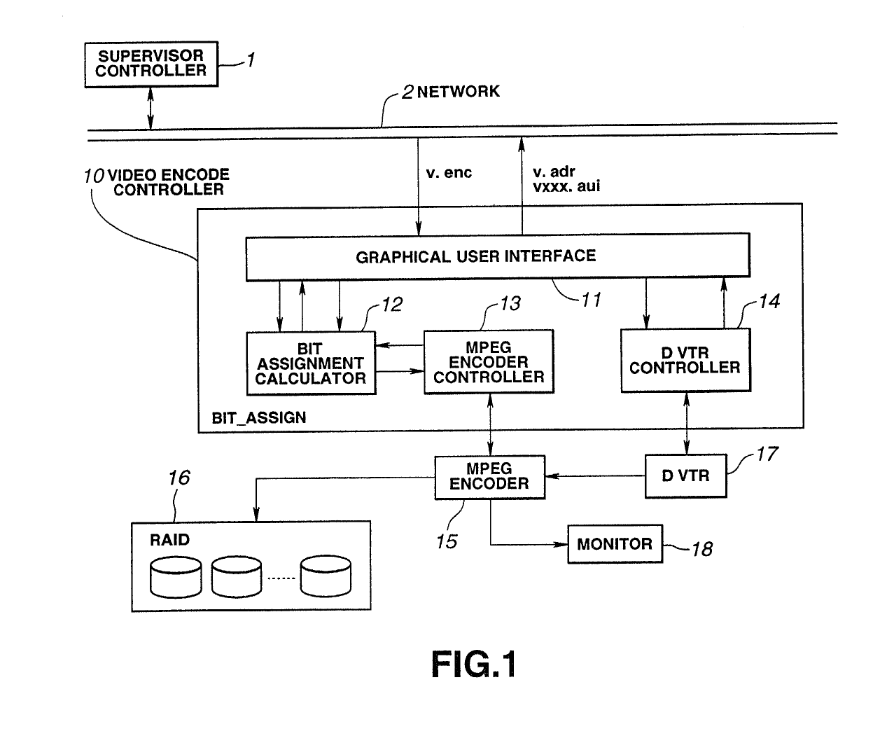

For example, FIG. 1 shows a specific example of a video encoding system for compression-encoding a video information for the aforementioned digital video disc by way of the aforementioned two-path encoding method.

In FIG. 1, a video encode controller 10 for controlling a video encoding is connected via a network 2 to a supervisor controller 1 which carries out management of the entire system.

The supervisor controller 1 is a controller which monitors an operation in the system as a whole among the programs constituting an operating system and executes a supervisor which is a program for effective control. This video encoding system carries out management of a DVD authoring system, assigns an encoding condition such as a video; audio, superimpose, menu, and the like to the encoding system, and receives a report on the encoding result.

In this example of the video encoding system, a video encoding condition is specified by a file v.enc for example. On the other hand, the video encode controller 10 reports an address v.adr written on a RAID 16 (redundant arrays of inexpensive discs) and a data (vxxx.aui) required when the a bit stream as the encoding result is multiplexed with a sub-picture such as audio, superimpose, menu, and the like. Here, the RAID 16 is a large-capacity recording medium for recording the bit stream as the encoding result and increases the recording capacity and transfer speed performance by connecting a plurality of hard discs (HDD) an the like in parallel.

The video encode controller 10 includes: a graphical user interface (GUI) 11/a bit assignment calculator 12 which contains a bit assignment calculation program (Bit_Assign) which will be detailed later; an MPEG encoder controller 13 for executing the bit assignment calculation program (Bit_Assign) contained in the bit assignment calculator 12; and a digital VTR controller 14.

A user uses the graphical user interface 11 for management of the aforementioned bit assign calculation program (BIT_ASSIGN) of the bit assignment calculator 12 and three programs of the MPEG encoder controller 13. Moreover, management of a DVD controller 14 can also be carried out.

the MPEG encoder controller 13 executes the aforementioned bit assignment calculation program (BIT_ASSIGN) of the bit assignment calculator 12 and controls the MPEG encoder 15. Moreover, the DVD controller 14 controls a DVTR 17. The DVTR 17 is connected to the MPEG encoder 15 which in turn is connected to a monitor 18 for displaying an encoding result. Furthermore, the MPEG encoder 15 is also connected to the RAID 16 for recording the encoding result.

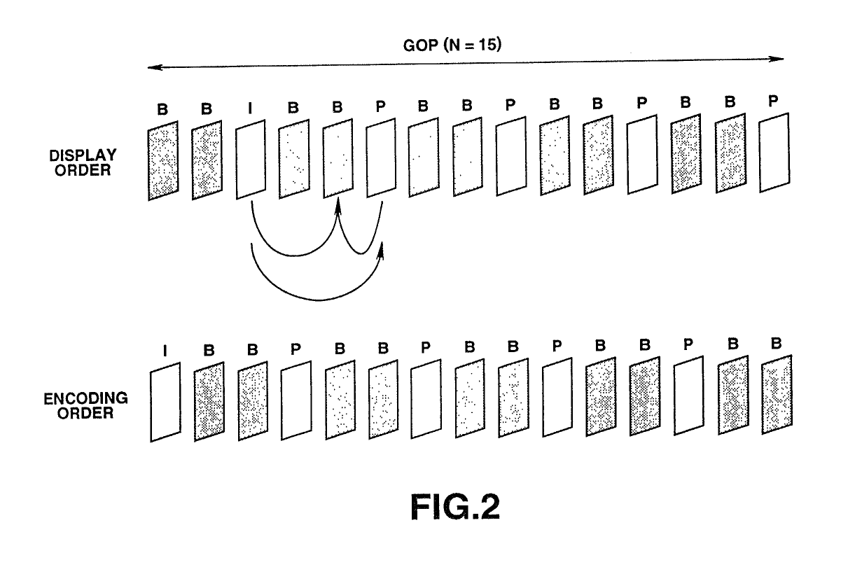

In the MPEG encoder 15, a temporal direction redundancy is removed by motion prediction for compressing a video information. Moreover, the MPEG encoder 15 carries out compression-encoding of the video information by using three types of pictures: I picture (intra coded picture) which is coded within a frame; P picture (predictive coded) which is coded by predicting a current state from a past screen; and B picture (bidirectionally predictive coded) which is coded by predicting a current state from both past and future images. Here, a group of pictures containing at least one I picture is treated as a GOP (group of pictures) as shown in FIG. 2. In FIG. 2, the number of frames contained in a GOP is 15. The head of a GOP in the display sequence is a B picture preceding an I picture and following a P or I picture. The end of a GOP is a first P picture preceding the next I picture.

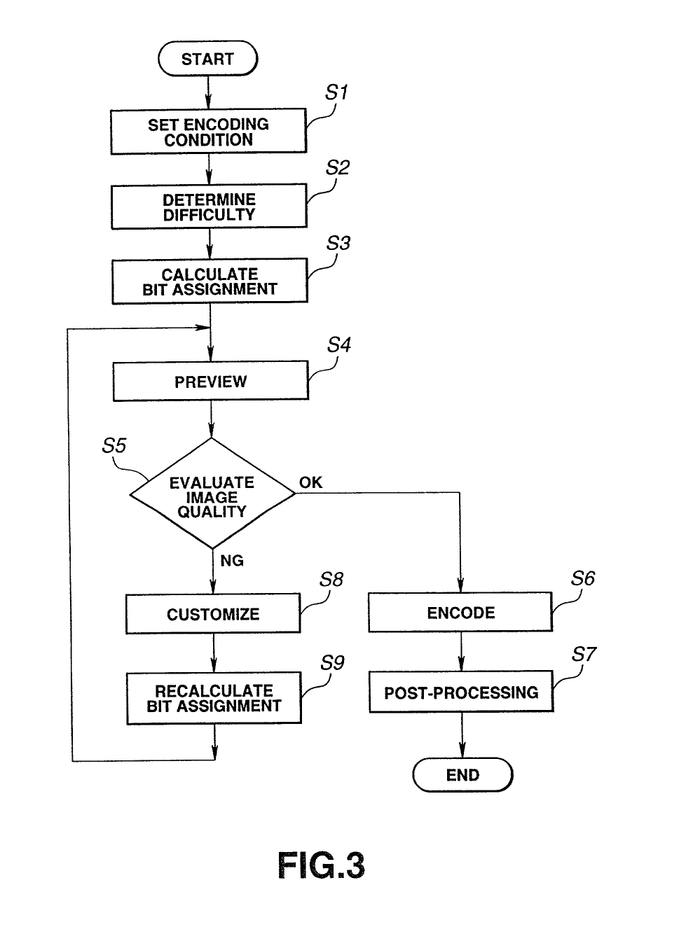

Explanation will now be directed on the operation of this video encoding system with reference to a flowchart of FIG. 3. Firstly, in step S1, the supervisor controller 1 transmits via the network 2 an encoding condition v.enc such as the total number of bits assigned for video and the maximum rate, and the MPEG encoder controller 13 sets the encoding condition. After this, in step S2, the MPEG encoder 15 determines the coding difficulty of the encode material under control of the MPEG encoder controller 13. Here, the DC value (average luminance within a frame) and the motion vector amount ME of each image are read in. According to the result obtained, a file is created. It should be noted that as the DC values increases, the picture beomes darker and as the DC values decreases, the picture becomes brighter.

The coding difficulty is actually determined as follows. A video information as the encode material is reproduced by the DVTR 17 from a digital video cassette which is a master tape. The MPEG encode controller 13 determines via the MPEG encoder 15 the coding difficulty of the video information reproduced by the DVTR 17.

Here, a bit amount generated is determined under the condition that the number of quantization steps is set to a fixed value for encoding. The bit amount generated is increased if the image has a plenty of high frequency components and the amount is decreased if the image is a still image or an image having a plenty of flat portions. This bit amount generated is used to determine the aforementioned coding difficulty.

Next, in step S3, according to the encode condition set in step S1 and the coding difficulty of each picture determined in step S2, the MPEG encode controller 13 executes the bit assignment calculation program (BIT_ASSIGN) in the bit assignment calculator 12, so as to carry out calculation of an assignment bit amount (target amount).

Here, the user determines according to the image quality of the local decoder output built in the MPEG encoder 15 whether to execute encoding by using the result of the bit assignment calculation in step S3.

Actually, without outputting to the RAID 16 the bit stream according to the aforementioned bit assignment, the user checks the image quality in step 4 by using a preview mode for an arbitrary processing range.

If the image quality is evaluated as having no problem in step S5, control is passed to step S6 where the MPEG encoder executes an encoding. If the image quality is evaluated to have a problem, control is passed to step S8 where a customizing work is carried out for image quality adjustment such as increasing the rate of the portion having a problem and adjusting the filter level. After this, in step S9, the bit assignment calculation program (BIT_ASSIGN) in the bit assignment calculator 12 is again executed for calculating the bit assignment.

After this, control is returned to step S4, so that a portion customized is previewed. In step S6, the image quality is checked. If there is no problem, control is passed to step S6, so that the MPEG encoder 15 executes the encodes the entire portion. In step S7, a bit stream as the result of encoding is transmitted via a SCSI (small computer system interface) so as to be directly written in the RAID 16.

After the encoding in step S6, the video encode controller 10 reports the aforementioned encode result information via the network to the supervisor controller 1.

In the flowchart of FIG. 3, the processing of each step is an off-line processing excluding the step S2, step S4, and step S6.

Hereinafter, description will be directed to the bit assignment calculation in the bit assignment calculator 12 executed in step S3 by the MPEG encode controller 13. Firstly, when the supervisor controller 1 specifies the aforementioned total bit amount (QTY_BYTES) and the maximum bit rate (MAXRATE), the MPEG encoder controller 13 determines a total bit amount (USB_BYTES) by adding a limit so as to make equal to or below the maximum bit rate (MAXRATE) and uses this value subtracted by a total bit amount required for the GOP header together with the total number of frames, so as to calculates a total target value SUPPLY_BYTES.

The bit assignment calculation program of the bit assignment calculator 12 is executed for assigning a bit amount (hereinafter, referred to as a target) for each picture, so as to be contained within a size of the SUPPLY-BYTES.

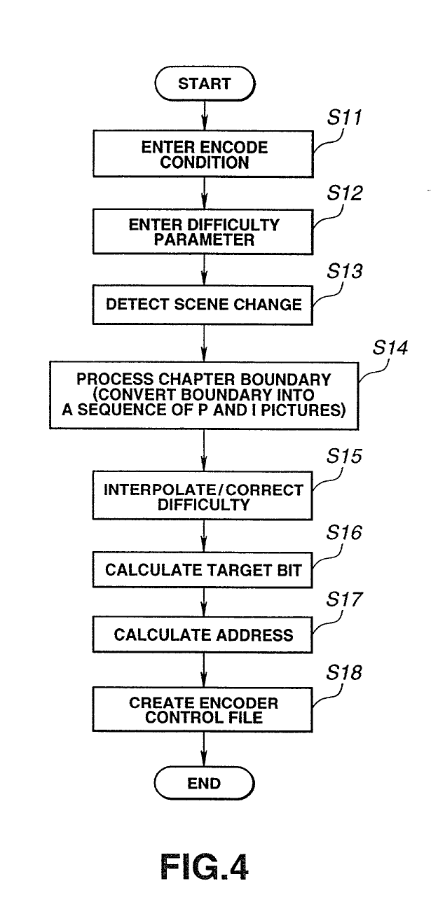

FIG. 4 is a flowchart showing a detailed processing of this bit assignment calculation in step S3.

Firstly, in step S11, as has been described above, when supplied with the total bit amount (QTY_BYTES) and the maximum bit rate (MAXRATE) from the supervisor controller 1, the MPEG controller 13 calculates the SUPPLY-BYTES as has been described above.

Next, in step S12, the aforementioned file created in determination of the coding difficulty in step S2 of FIG. 3 is directly read in, and in step S13 a scene change point is detected according to a change amount of parameters of the image DC values and motion vectors ME determined together with the coding difficulty.

The scene change detection of this step S13 is a processing for detecting a scene change point according to the “video signal processing apparatus” disclosed in Specification and Drawings of Japanese Patent Application 8-274094 filed by the applicant of the present invention.

This “video signal processing apparatus” detects a DC level of each frame of a video signal and obtains an error value by curve-fitting this DC level, so as to detect a frame of a scene change of the aforementioned video signal.

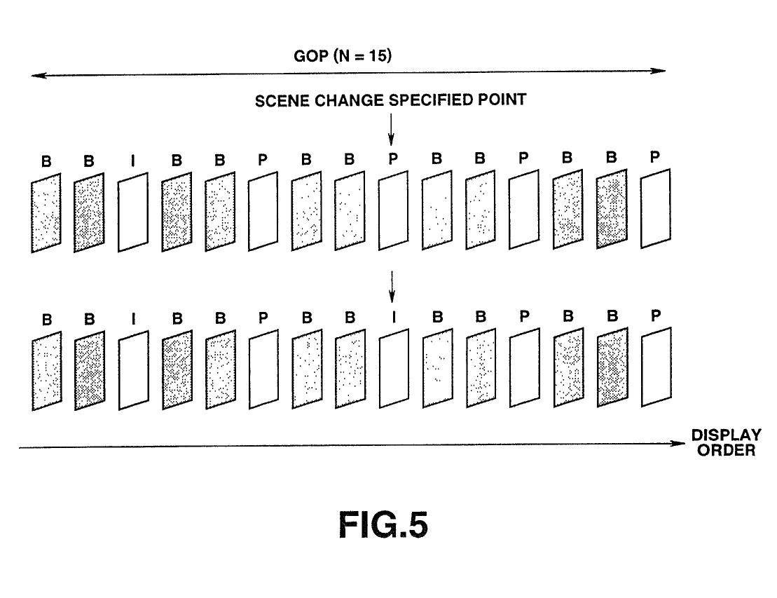

As shown in FIG. 5, when a scene change point is detected, the frame containing the scene change point is modified from a P picture into an I picture, so as to improve the image quality.

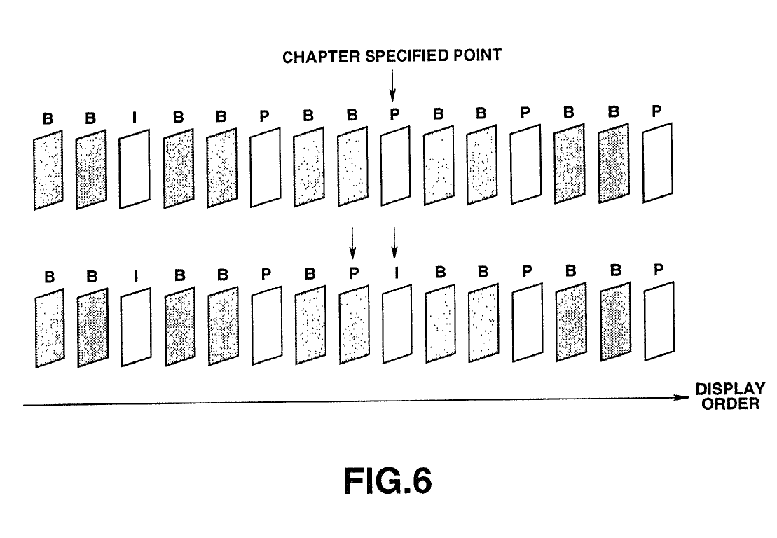

Next, in step S14, a chapter boundary processing is carried out. During a chapter search in a DVD reproduction apparatus, jump is carried out from an unspecified picture. In this case, too, in order eliminate disorder of the reproduced image, as shown in FIG. 2, the picture type is modified so that the chapter is at the head of a GOP. In FIG. 6, a P picture is modified into an I picture.

As a result of the sequence of processes in step S12 and step 13, modification of the picture type (I, P, and B pictures) is executed, which in turn modifies the picture type in coding difficulty determination. To cope with this, in step S15, the coding difficulty value is interpolated/corrected according to the picture type after the modification.

According to the coding difficulty obtained by the interpolation/correction in step S15 and the total bit amount (SUPPLY_BYTES), in step S16, a target bit amount is calculated for each picture.

In step S17, an address calculation is carried out for writing into the RAID 16 the bit stream as the encoding result, and control is passed to step S18 where a control file is created for the encoder.

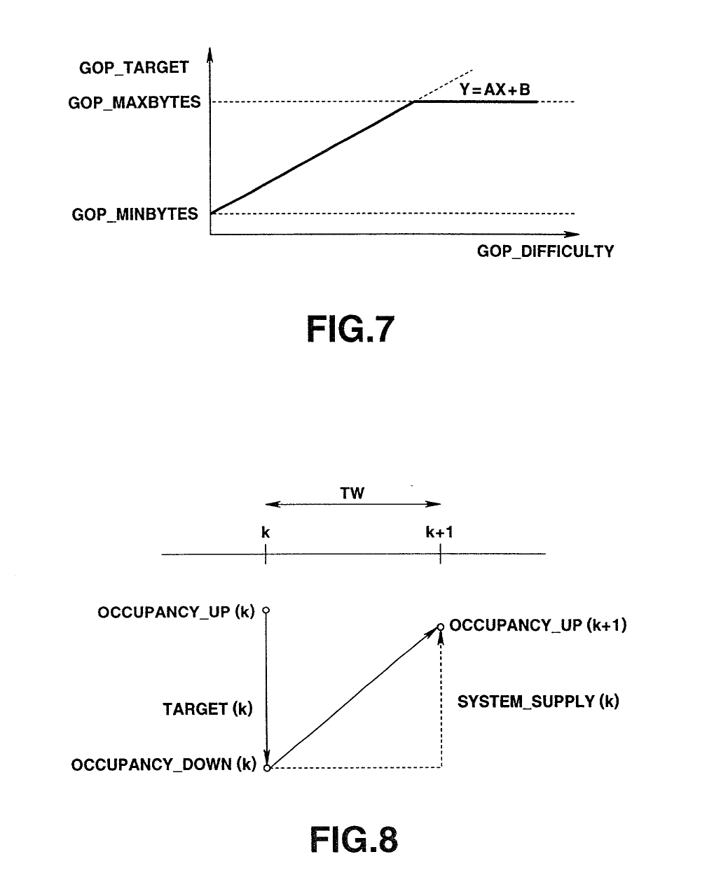

As an example of the bit assignment calculation, an explanation will be given for a case in which firstly, bit amount is assigned on GOP basis and after this, a bit assignment is carried out according to the coding difficulty of each of the pictures contained in the GOP. Here, a bit assignment amount (GOP_TARGET) on GOP basis for encoding is determined according to GO_DIFF which is a sum of coding difficulties of each GOP. FIG. 7 shows an example of the simplest function for converting the GOP_DIFF and the GOP_TARGET.

In this example, an evaluation function Y=AX+B is used assuming that the vertical axis Y represents the GOP_TARGET and the horizontal axis represents the GOP_DIFF. It should be noted that the total of the coding difficulties of all the pictures (DIFFICULTY_SUM) is calculated in advance.

Firstly, by using the total bit amount QTY_BYTES and the maximum bit rate MAXRATE given from the supervisor controller 1, the total bit amount USB_BYTES limited so as to be equal to or below the maximum bit rate is obtained as follows.

USB_BYTES=min (QTY_BYTES, MAXRATE×KT×total_frame_number) (1)

Here, in the case of the NTSC, KT=1/8 (bits)/30 (Hz); and in the case of PAL, 1/8 (bits)/25 (Hz). Moreover, total_frame_number represents the total number of material frames to be encoded, and the min (s, t) is a function to select a smaller of s and t.

Moreover, the SUPPLY_BYTES is obtained by subtracting the number of bits required for the GOP header TOTAL_HEADER from the USB_BYTES obtained from the aforementioned Equation (1).

SUPPLY_BYTES=USB_BYTES−TOTAL_HEADER (2)

Next, the total of the coding difficulties of all the pictures of the GOP can be expressed as follows.

DIFFICULTY_SUM=Σdifficulty (3)

Moreover, the minimum value of the GOP_TARGET is assumed to be as follows.

B=GOP₋MINBYTES (4)

Then, it is possible to obtain the evaluation function as shown in FIG. 7.

Σy=Z×Σx+B×n

Here, ΣY=SUPPLY_BYTES; Σx=DIFFICULTY_SUM; and n represents the total number of GOPs.

Therefore, A=(SUPPLY_BYTES−B×n)/DIFFICULTY_SUM. Then the target value of each GOP can be expressed as follows.

GOP_TARGET=A×GOP_DIFF+B (5)

After this, bit assignment is carried out within each of the GOPs, according to the coding difficulty of each picture If the bit assignment within a GOP is carried out in proportion to the coding difficulty, the target amount of each picture can be obtained by Equation (6) as follows.

target (k)=GOP_TARGET×difficulty (k)/GOP_DIFF (6)

(wherein k represents the number of pictures in the GOP: 1≦k≦GOP)

In this case, if a picture having an extremely high difficulty (extremely large GOP_DIFF), an extremely large GOP_TARGET is obtained, exceeding the maximum rate allowed in the system and accordingly, it is necessary to apply a limiter with a fixed amount such as GOP_MAXBYTES. Moreover, the minimum target amount is also limited with the GOP_MINBYTES. More specifically, this is realized by using the algorithm as follows.

In an MPEG video encoding, the bit assignment should be carried out while considering a remaining buffer amount of a virtual decoder. The calculation of this virtual buffer remaining amount is called VBV (Video Buffering Verifier).

Firstly, the VBV calculation method will be explained with reference to FIG. 8. The first term OCCUPANCY_UP(0) in this calculation, as shown in Equation (7), starts from a fixed value (VBVMAX*2/3 in this example).

OCCUPANCY_UP(0)=VBVMAX*2/3 (7)

After this, OCCUPANCY_UP represents an upper point of each picture and OCCUPANCY_DOWN represents a lower point of each picture shown above the graph.

For a DVD buffer size VBVMAX (1.75 Mbits), assuming that Occupancy_up(k) is a start point of buffer of the k-th picture and target (k) is a target amount of the k-th picture, the remaining buffer amount OCCUPANCY_DOWN(k) after discharging the bits for the picture can be expressed by Equation (8) which will be detailed later. In this buffer, a data amount (SYSTEM_SUPPLY) of a bit rate according to the video data amount from a decoder pickup is accumulated. After supplying this, the remaining buffer amount OCCUPANCY_UP(k+1) is expressed by Equation (9) as follows.

OCCUPANCY_DOWN(k)=OCCUPANCY_UP(k)−target(k) (8)

OCCUPANCY_UP(k+1)=OCCUPANCY_DOWN(k)+SYSTEM_SUPPLY (9)

The remaining buffer amount after this supply is indicated by the amount increased toward the upper right in FIG. 8. The inclination is increased as the bit rate supplied is increased so that a data can easily be stored in the buffer. When the buffer has become full, supply from the pickup to the buffer is stopped and accordingly, there is no need of consideration on the buffer overflow. This means that the buffer amount need not be exactly at a set value but can be controlled so as to be equal to or above the set value.

On the contrary, if the picture data amount is too large, the data accumulated in the buffer is decreased. The target amount is calculated so that this remaining buffer amount is above a predetermined value. The SYSTEM-SUPPLY of the data amount of the bit rate according to the video data amount is obtained as follows.

SYSTEM_SUPPLY=MAXRATE (bps)*KT (10)

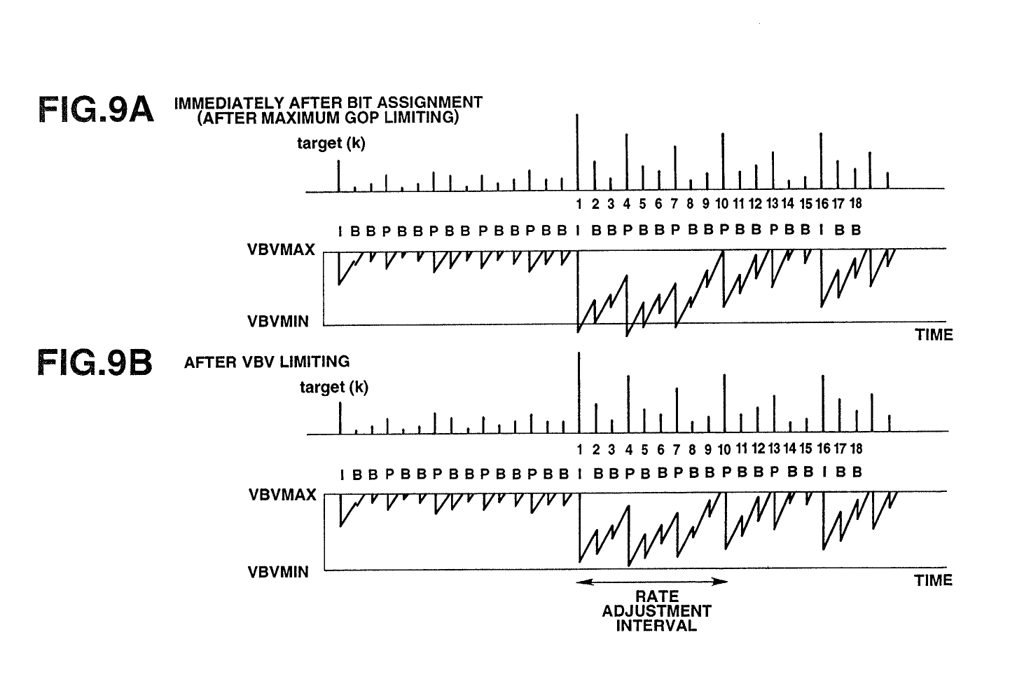

FIG. 9 shows an example of the target bit assignment calculation on GOP basis. FIG. 9A shows a case when the aforementioned VBV buffer calculation is carried out for a target amount obtained by considering the evaluation function and the GOP_MAXRTE limit. In this FIG. 9A, the pictures No. 1, No. 4 and No. 7 are found below the VBVMIN which is the lower limit of the VBV buffer. To cope with this, the target amount is decreased for the GOP containing the pictures having VBV below VBVMIN. If Occ_min is the minimum value of OCCUPANCY when the VBV calculation is carried out with the target amount prior to addition of the VBV limit within the GOP, then the adjustment amount can be expressed by Equation given below. Here, the start point kstart for limiting is a value of k when OCCUPANCY_UP(k) is equal to or above a reference value (VBVLINE; VBVMAX*3/4 for example), and the value of OCCUPANCY_UP(k) in this condition is assumed to be Occ_start.

When OCCUPANCY_MIN , VBVMIN,

r=(Occ-start−VBVMIN)/(VBVSTART−Occ_min) (11)

It is assumed that target(j)=target (j)×r (kstart≦j≦k) for each of the targets.

By using the target amount thus obtained for creating a control file for encoding, it is possible to carry out a variable bit rate encoding according to the difficulty of the material image.

By the way, in a video material edited, a fade-out and/fade-in technique is often used for switching from one scene to another by gradually making the screen darker and again brighter.

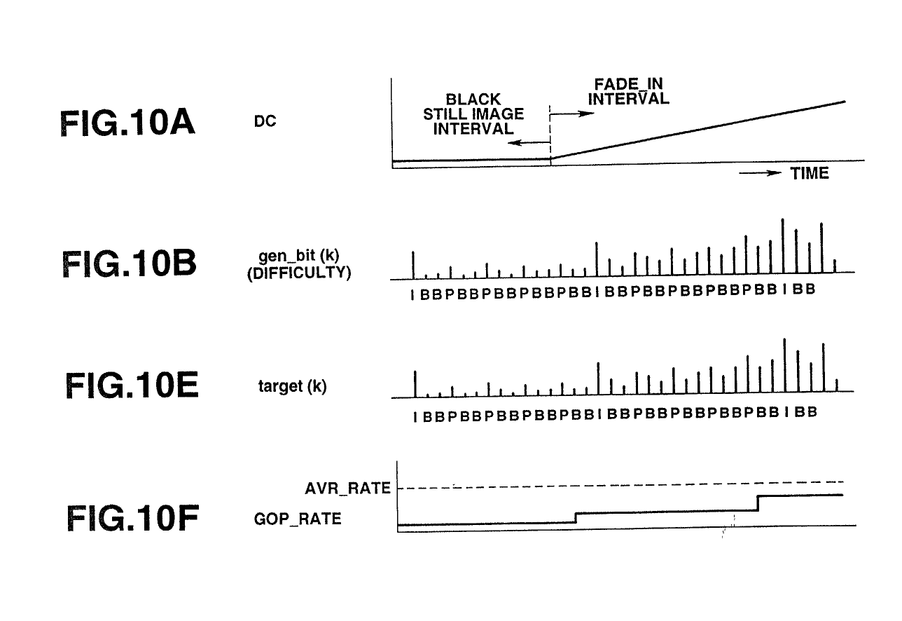

FIG. 10 shows an example of fade-in from a dark screen FIG. 10A shows a luminance change of the average value DC on frame bases. For example, the DC is expressed in 256 steps from 0 to 255, wherein a greater number represents a brighter state and a smaller number represents a darker state. FIG. 10B shows the value gen-bit(k) of the coding difficulty of the k-th frame determined by a tentative encoding. This value gen_bit(k) increases as the image becomes complicated. For example, if the image is simple such as a dark still screen, the gen_bit of an I picture becomes smaller. Moreover, if no motion is present, the frame correlation becomes greater and accordingly, P pictures and B pictures also have gen_bit(k) values which are very small.

In the fade-in interval shown in FIG. 10A, the I picture has a different DC level from that of the following P and B pictures and accordingly, the frame correlation decreases. Consequently, as shown in FIG. 10B, the gen_bit values of the P and B picrtures increase relatively.

FIG. 10C shows target bit amounts target(k) assigned for I, B, and P pictures according to the gen-bit shown in FIG. 10B. Moreover, FIG. 10D shows the bit rate assignment for the fade-in interval according to the target bit amounts target(k) shows in FIG. 10C.

Because a dark scene has a lower complexity than an ordinary moving picture scene, the coding difficulty is lower than an average coding difficulty. As the entire bit rate assignment is determined by the coding difficulty value, the bit rate is decreased at such a dark fade-in/fade-out point.

However, the human visual sensitivity is high for a dark scene and a noise in a dark screen can easily be perceived. Consequently, there is a problem that the noise is vary remarkable unless the bit rate at the dark fade-in/fade-out point is sufficiently high.

### SUMMARY OF THE INVENTION

It is therefore an object of the present invention to provide a image encoding method and apparatus, recording medium, and an image transmission method which are capable of improving the image quality at a fade-in/fade-out point by assigning in a rate assignment calculation a higher rate than in a normal processing.

The video encoding method and apparatus according to the present invention, in order to achieve the aforementioned object, detects an interval of bright/dark change via a dark portion according to a temporal change of an average luminance level within the frame, and corrects the coding difficulty for this interval, so that the bit assignment amount is determined according to the corrected coding difficulty. Consequently, the bit assignment amount corrected is in the vicinity of the average bit rate.

The video encoding method and apparatus according to the present invention, in order to achieve the aforementioned object, detect an interval of bright/dark change via a dark portion according to a temporal change of an average luminance on a video encoding group basis consisting of at least one intra-frame coded picture, a frame-to-frame forward predictive coded picture, and a bidirectional coded picture, and correct the coding difficulty for this interval, so that the assignment amount is determined according to the corrected coding difficulty.

Moreover, the video encoding method and apparatus according to the present invention, in order to achieve the aforementioned object, detect an interval of bright/dark change via a dark portion according to a temporal change of an average luminance on a video encoding group basis consisting of at least one intra-frame coded picture, a frame-to-frame forward predictive coded picture, and a bidirectional coded picture and according to a temporal change of ratio of coding difficulty of a particular picture, and correct the coding difficulty for this interval, so that the assignment amount is determined according to the corrected coding difficulty.

Moreover, the recording medium according to the present invention, in order to achieve the aforementioned object, contains a video data in which an interval of bright/dark change via a dark portion is detected according to a temporal change of an average luminance level within the frame, and the coding difficulty for this interval is detected, so that the bit assignment amount is determined according to the corrected coding difficulty.

Moreover, the recording medium according to the present invention, in order to achieve the aforementioned object, contains a video data in which an interval of bright/dark change via a dark portion is detected according to a temporal change of an average luminance on a video encoding group basis consisting of at least one intra-frame coded picture, a frame-to-frame forward predictive coded picture, and a bidirectional coded picture, and the coding difficulty for this interval is corrected, so that the assignment amount is determined according to the corrected coding difficulty.

Moreover, the recording medium according to the present invention, in order to achieve the aforementioned object, contains a video data in which an interval of bright/dark change via a dark portion is detected according to a temporal change of an average luminance on a video encoding group basis consisting of at least one intra-frame coded picture, a frame-to-frame forward predictive coded picture, and a bidirectional coded picture and according to a temporal change of ratio of coding difficulty of a particular picture, and the coding difficulty for this interval is corrected, so that the assignment amount is determined according to the corrected coding difficulty.

Moreover, the video transmission method according to the present invention, in order to achieve the aforementioned object, detects an interval of bright/dark change via a dark portion according to a temporal change of an average luminance level within the frame, and corrects the coding difficulty for this interval, so that the bit assignment amount is determined according to the corrected coding difficulty.

Moreover, the video transmission method according to the present invention, in order to achieve the aforementioned object, detects an interval of bright/dark change via a dark portion according to a temporal change of an average luminance on a video encoding group basis consisting of at least one intra-frame coded picture, a frame-to-frame forward predictive coded picture, and a bidirectional coded picture, and corrects the coding difficulty for this interval, so that the assignment amount is determined according to the corrected coding difficulty.

Moreover, the video encoding method and apparatus according to the present invention, in order to achieve the aforementioned object, detects an interval of bright/dark change via a dark portion according to a temporal change of an average luminance on a video encoding group basis consisting of at least one intra-frame coded picture, a frame-to-frame forward predictive coded picture, and a bidirectional coded picture and according to a temporal change of ratio of coding difficulty of a particular picture, and corrects the coding difficulty for this interval, so that the assignment amount is determined according to the corrected coding difficulty.

### BRIEF DESCRIPTION OF PREFERRED EMBODIMENTS

FIG. 1 is a block diagram showing an example of a conventional video encoding system FIG. 2 explains a GOP configuration.

FIG. 3 is a flowchart showing an encoding procedure in the aforementioned conventional video encoding system.

FIG. 4 is a flowchart showing a bit assignment calculation in the encoding procedure shown in FIG. 3.

FIG. 5 explains modification of the picture type when a scene change is specified.

FIG. 6 explains modification of the picture type when a chapter is specified.

FIG. 7 shows a characteristic of an evaluation function on GOP basis.

FIG. 8 shows a characteristic for explanation of the VBV calculation method.

FIG. 9 shows an example of the target bit assignment.

FIG. 10 shows a timing chart for explanation of the rate assignment processing in a fade-in interval by the conventional video encoding system.

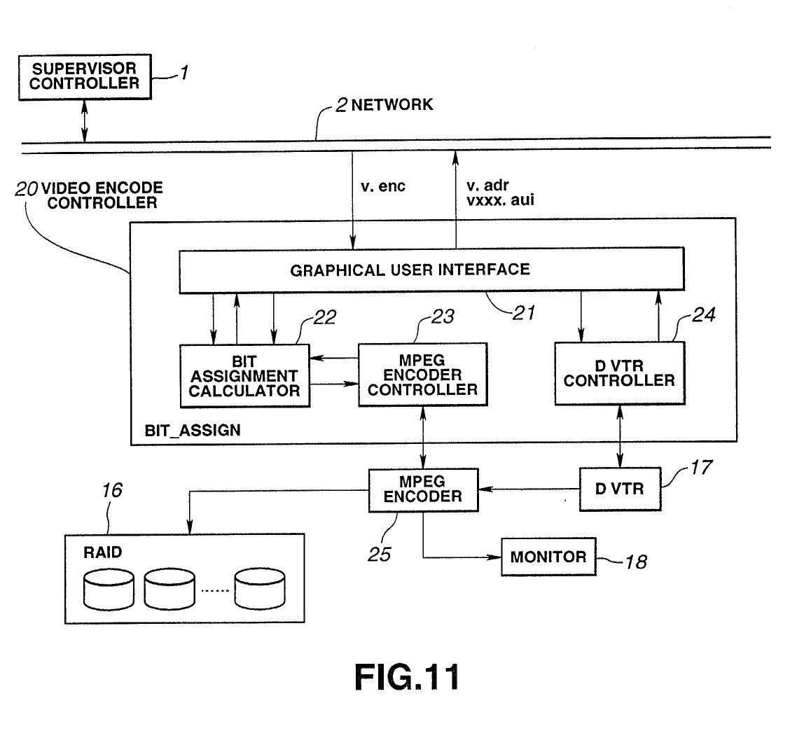

FIG. 11 is a block diagram showing a specific example of a video encoding system as an embodiment of the video encoding method and apparatus according to the present invention.

FIG. 11 is a flowchart for explaining a bit assignment calculation executed by a bit assignment calculator in a video encode controller used in the aforementioned video encoding system.

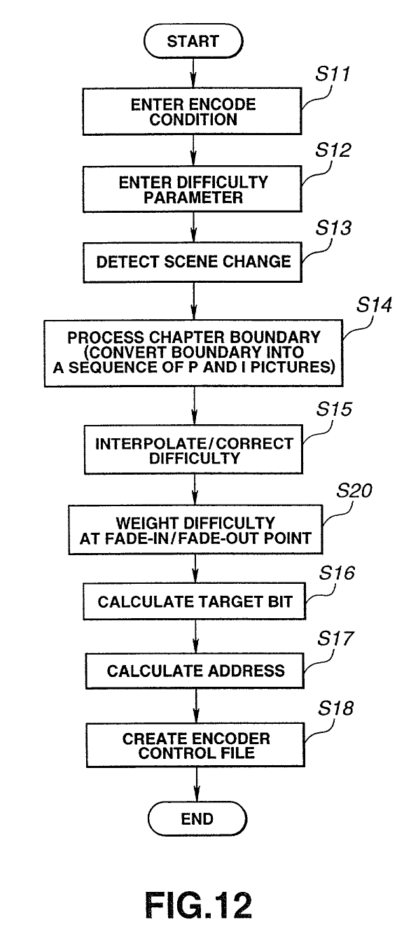

FIG. 12 is a timing chart for explaining the overall operation of the video encoding system as the aforementioned embodiment.

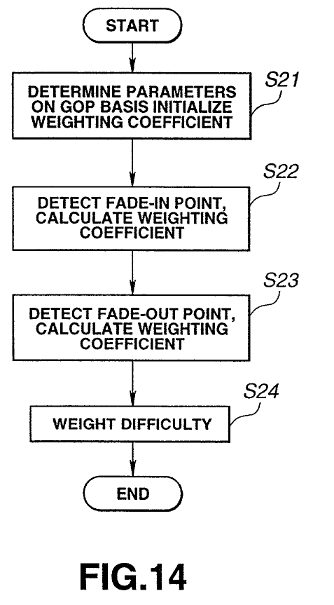

FIG. 14 is a flowchart for explaining weighting of DIFFICULTY at a fade-in/fade-out point in the aforementioned video encoding system.

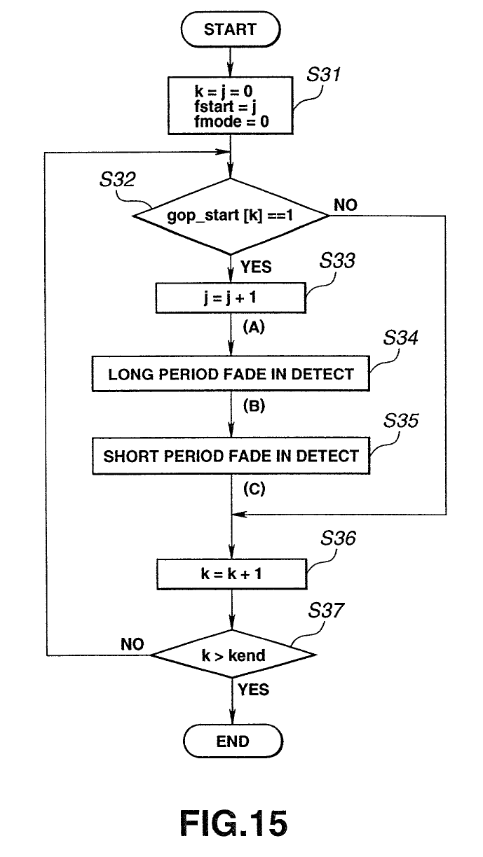

FIG. 15 is a flowchart shwoing a detection procedure for detecting a fade-in point in the aforementioned video encoding system.

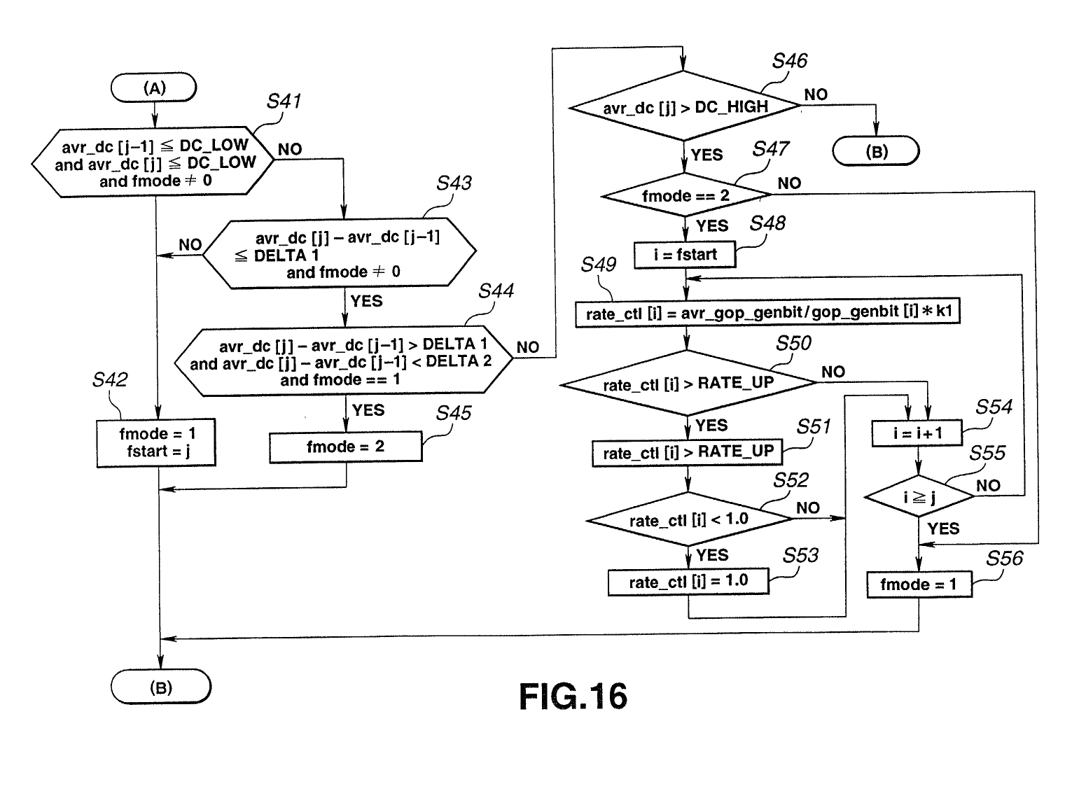

FIG. 16 is a flowchart for explaining a detection step for detecting a slow fade-in point in the aforementioned video encoding system.

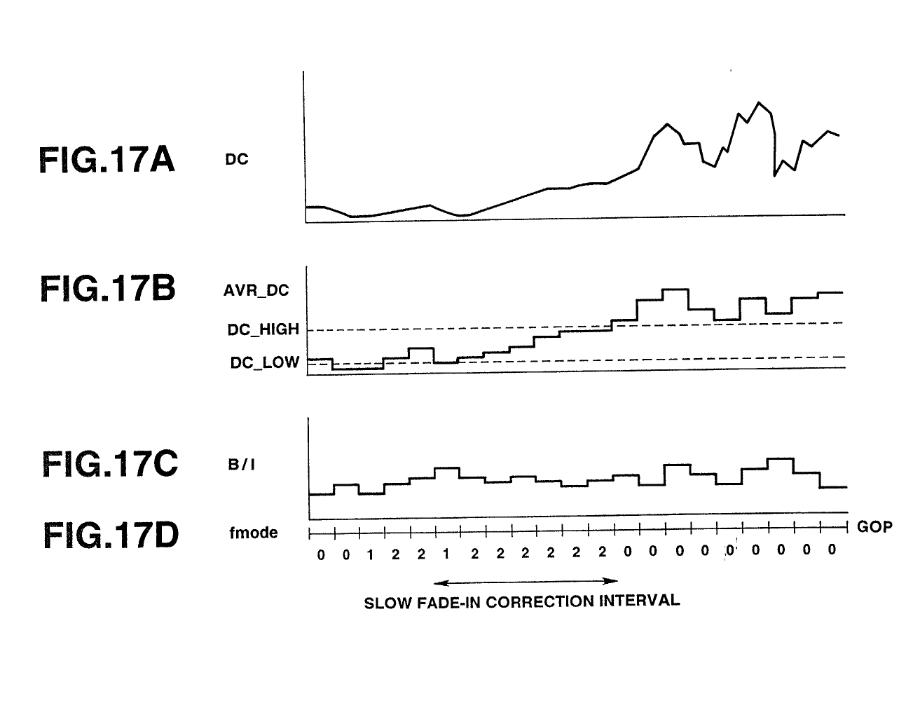

FIG. 17 is a timing chart for explaining a detection procedure for detecting a fade-in point which slowly rises.

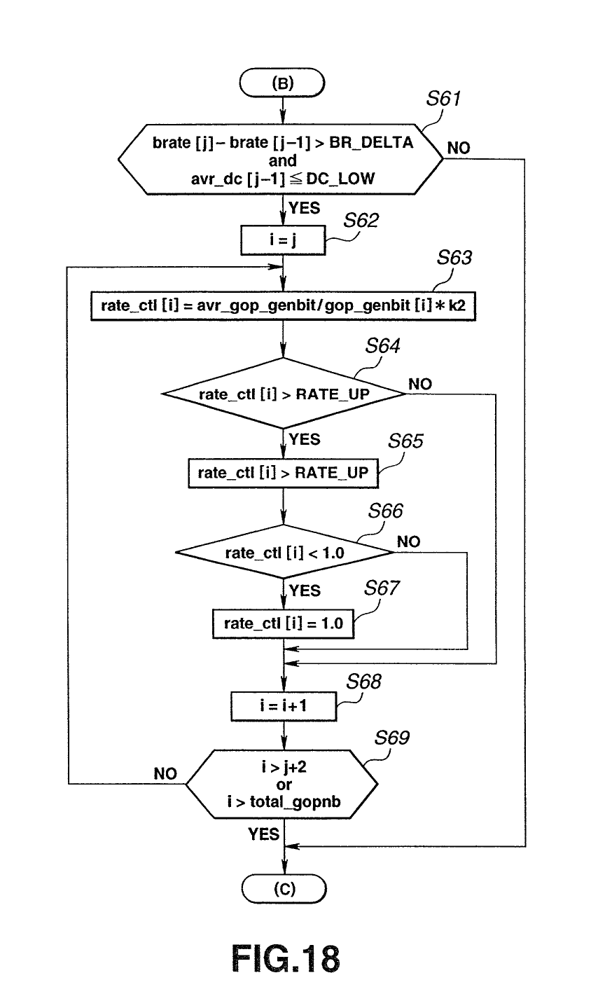

FIG. 18 is a flowchart for explaining a detection procedure for detecting a normal fade-in point in the aforementioned video encoding system.

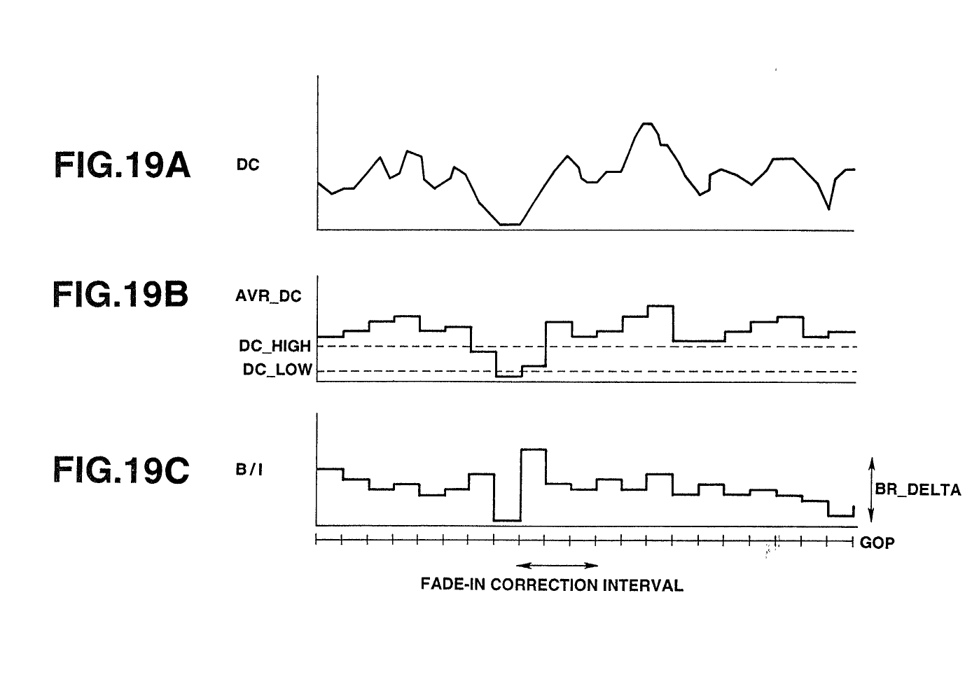

FIG. 19 is a timing chart for explanation of a detection procedure for detecting a normal fade-in point.

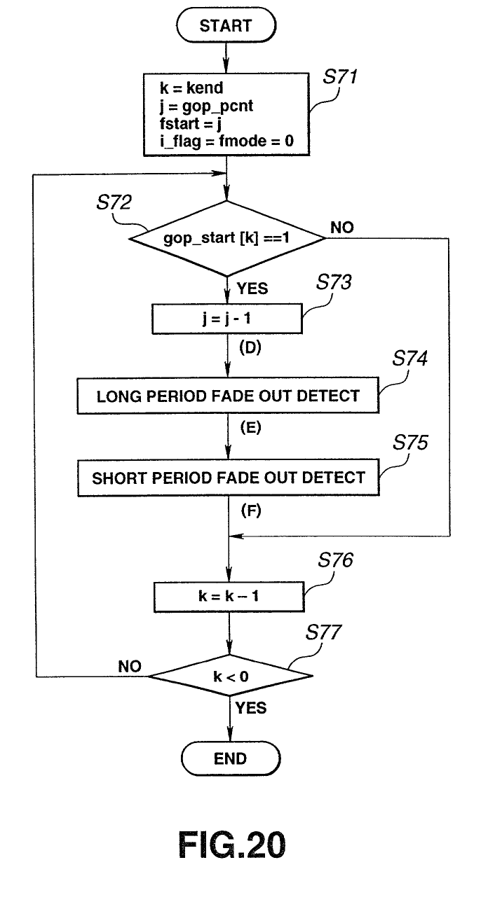

FIG. 20 is a flowchart showing a detection procedure for detecting a fade-out point in the aforementioned video encoding system.

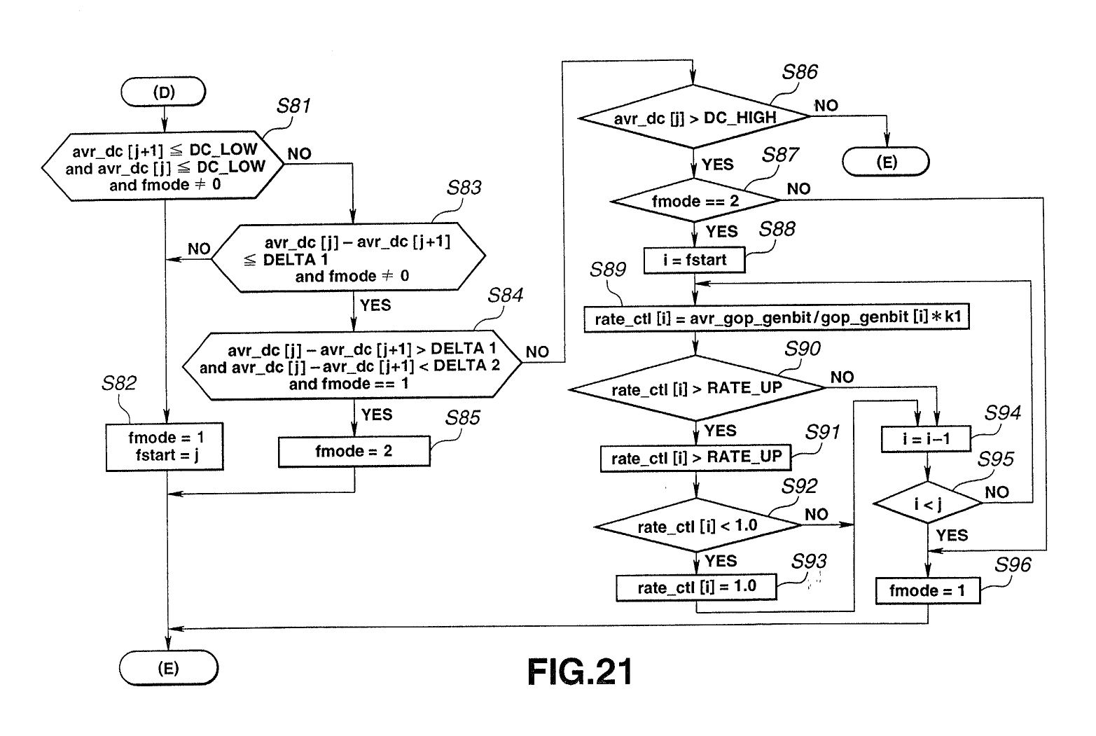

FIG. 21 is a flowchart showing a detection step for detecting a slow fade-out point in the aforementioned video encoding system.

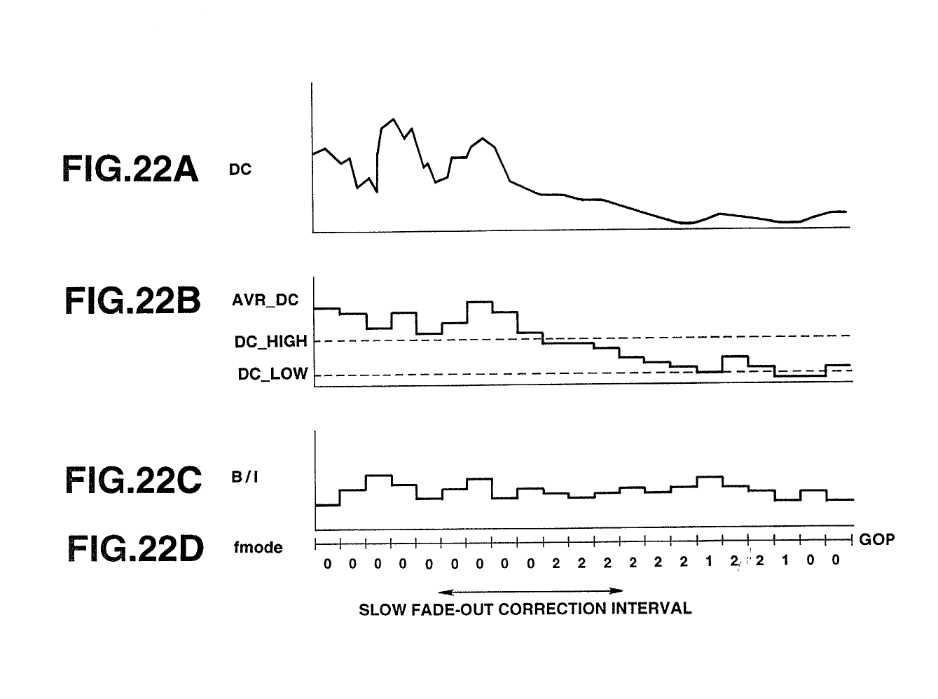

FIG. 22 is a timing chart for explaining a detection procedure for detecting a fade-in point which is slowly lowered.

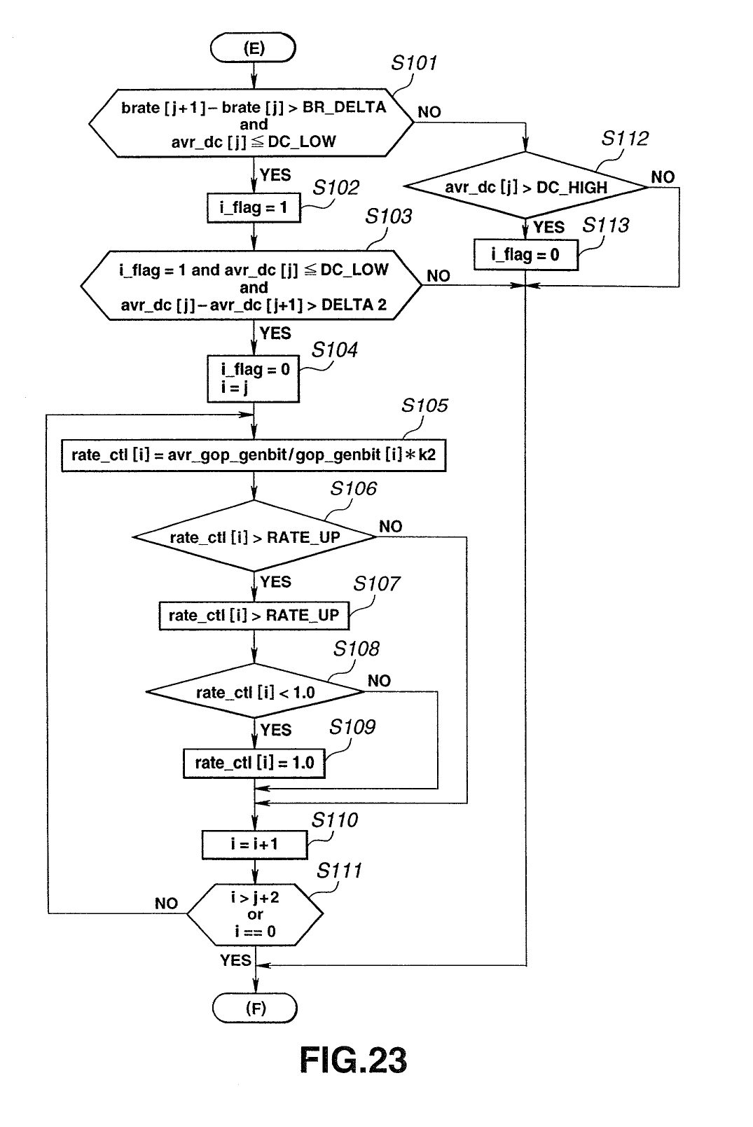

FIG. 23 is a flowchart for explaining a detection procedure for detecting a normal fade-out point in the aforementioned video encoding system.

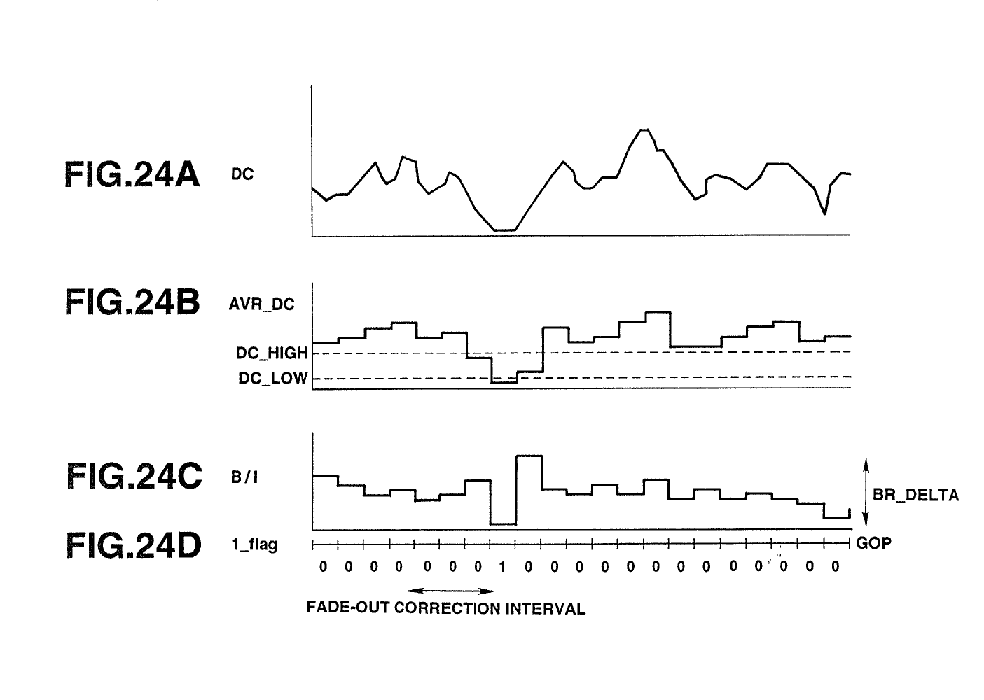

FIG. 24 is a timing chart for explanation of a detection procedure for detecting a normal fade-out point.

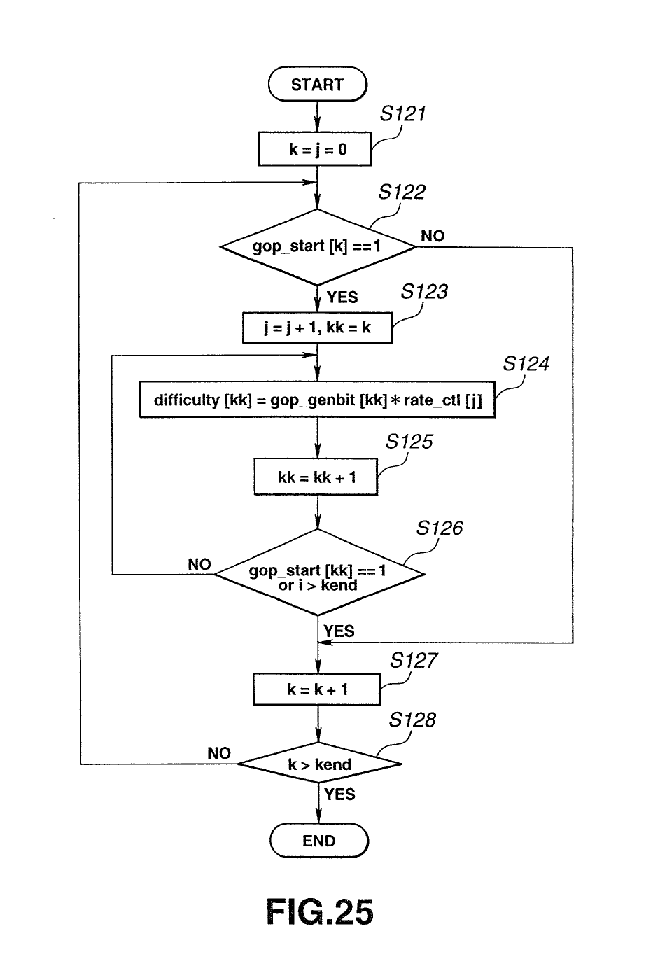

FIG. 25 is a flowchart showing a difficulty weighting procedure at a fade-in/fade-out point.

### DETAILED DESCRIPTION OF PREFERRED EMBODIMENTS

Hereinafter, description will be directed to the video encoding method and apparatus according to an embodiment of the present invention with reference to the attached drawings.

FIG. 11 shows a configuration of a video encoding system according to the embodiment for encoding a video material recorded on a digital video cassette tape for example, by employing the two-path encoding method.

This video encoding system has a basic configuration identical to that of the video encoding system shown in FIG. 1 excluding that a video encode controller 20 carries out a bit assignment calculation which is different from the conventional calculation procedure.

The video encoding system shown in FIG. 11 carries out a bit assignment calculation as shown in FIG. 12 according to a program which employs a video encoding method as follows. In a video material, according to an average luminance level and a time change amount within a frame, an interval is detected where a dark/bright state is switched via a dark portion such as a fade-in/fade-out interval. For such intervals, a coding difficulty value which represents an image complexity is multiplied by a weighting coefficient, for correcting the coding difficulty. According to the coding difficulty corrected, the entire bit rate assignment is carried out.

This bit assignment calculation is controlled by an MPEG encoder controller 23, so as to be executed by a bit assignment calculator 22.

This bit assignment calculation will be detailed below with reference to the flowchart of FIG. 12.

This bit assignment calculation procedure shown in FIG. 12 contains a step S20 inserted between the steps S15 and S16 in the flowchart of the aforementioned FIG. 4. In step S20, weighting of difficulty is carried out at a fade-in/fade-out point.

Hereinafter, description will be directed to this step S20 for executing the difficulty weighting procedure at the fade-in/fade-out point.

This step S20 detects in an input image as a video material, a fade-in/fade-out interval according to an average luminance level change along the time axis and the I picture coding difficulty ratio within a GOP, and multiplies the coding difficulty of this interval by a weighting coefficient for correcting the coding difficulty.

In the next step S16, according to this coding difficulty corrected, the target bit amount is calculated and carries out the entire bit rate assignment, so as to guarantee that the bit rate will not be decreased extremely.

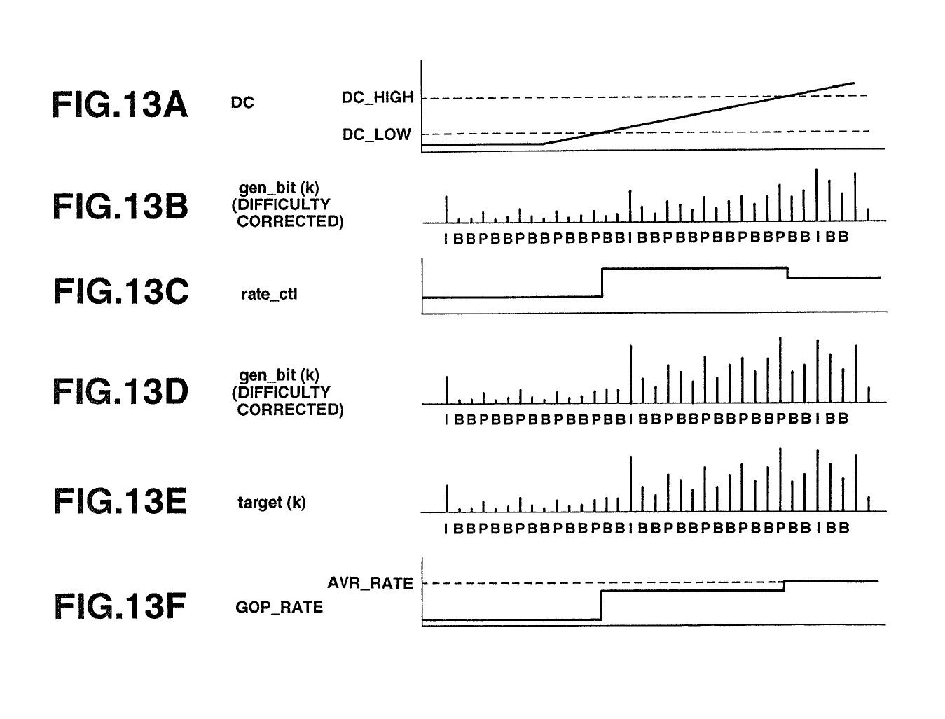

Explanation will be given on the processes executed in these steps S20 and S16 using a specific example of fade-in from a dark scene with reference to FIG. 13.

FIG. 13A shows a change of the DC value. FIG. 13B shows gen_bit(k) of the coding difficulty of the k-th frame determined by a tentative encoding. FIG. 13C shows the weighting coefficient rate_ctl. FIG. 13D shows the coding difficulty value gen_bit(k) of the k-th frame which has been corrected by the aforementioned weighting coefficient rte-ctrl. FIG. 13E shows the target bit amount target(k) assigned for the I, B, and P pictures according to the gen_bit(k) after the correction shown in FIG. 13D. Moreover, FIG. 13F shows the bit rate assignment for the fade-in interval according to the target bit amount target(k) of FIG. 13E.

In step S20 of FIG. 12, the fade-in interval shown in FIG. 13A is detected from the average luminance level and the temporal change within a frame, and the coding difficulty value gen_bit(k) shown in FIG. 13B is multiplied by the weighting coefficient rate_ctl shown in FIG. 13C, so as to obtain the corrected coding difficulty value gen-bit(k) as shown in FIG. 13D. Here, the corrected coding difficulty value gen_bit(k) is obtained by making the weighting coefficient rate_ctl of the fade-in interval greater than the initial value (1).

Next, in step S16 of FIG. 12, according to the corrected coding difficulty value gen bit(k) shown in FIG. 13D, the target amount assignment is carried out, thus enabling to assure a bit rate sufficiently near to the average bit rate as shown in FIG. 13F.

The difficulty weighting process at the fade-in/fade-out point in the aforementioned step S20 is realized as steps S21 to S24 of FIG. 14.

Step S21 determines the parameters on GOP basis and initializes the weighting coefficient. A fade-in point detection of step S22 and a fade-out point detection of step S23 which will be detailed later use an average DC value avr_dc on GOP basis as the average luminance; and the coding difficulty ratio b-rate of the B picture to the I picture as the I picture coding difficulty ratio within the GOP. In order to obtain these avr_dc and b_rate, it is necessary to determine the parameters on GOP basis in advance.

For example, avr_dc[j] which represents an average DC value of the j-th GOP (1≦j≦total_gopnm) can be expressed as follows: avr_dc=GOP_dc/GOP/pcnt, wherein gop_dc is a sum of the DC values on GOP basis; GOP_pcnt is the number of pictures contained in the GOP; and total_gopnb is the total number of GOPs.

Moreover, b_rate[j] which represents the coding difficulty ratio between the B picture and I picture in the j-th GOP can be expressed as follows: b_rate[j]=b_bits/b_nb/i_bits, wherein b-bits is a sum of the B picture difficulty values in the GOP; b_nm is the number of B pictures in the GOP; and i_bits is the I picture difficulty value in the GOP.

Moreover, avr_gop_genbit which represents an average value of the sum of the difficulty values determined by tentative coding on GOP basis can be expressed as follows: avr-gop-genbit=Σgop_genbit/total_gopnb, assuming that gop genbit[j] is a sum of the difficulty values of the j-th GOP determined by tentative encoding on GOP basis.

Moreover, rate_ctl[j] which represents the weighting coefficient of the difficulty of the j-th GOP is set to 1.0 at initialization.

Moreover, as for the gop_start[k] which represents a start of a GOP, if the k-th frame is the head of a GOP, “1” is set, and otherwise, “0” is set.

Next, step S22 detects a fade-in point and calculate the weighting coefficient rate_ctl[j], and step S23 detects a fade-out point and calculates the weighting coefficient rate_ctl.

After this, in step S24, the gop_genbit determined by the GOP tentative encoding is multiplied with the aforementioned respective weighting coefficients rate_ctl[j] for weighting the difficulty, so as to obtain the corrected GOP coding difficulty value gop_genbit.

As the fade-in and fade-out speed is not constant, different detection methods are used for a slow change and a normal speed change in the fade-in point detection and the weighting coefficient calculation of step S22 and in the fade-out point detection and the weighting coefficient calculation of step S23.

When actually editing a video material, there are two different cases: a slow smooth bright/dark change such as slowly displaying a title from a dark scene or a sunset scene for setting the sun slowly to darkness; and an ordinary bright/dark change for switching from a scene to another in which a bright scene is changed to a dark scene and then to a bright scene.

Hereinafter, for each of these cases, i.e., a case of a slow smooth bright/dark change and an ordinary speed bright/dark change, explanation will be given on the fad-in point detection and fade-out detection in the aforementioned fade-in interval and the fade-out interval as well as the weighting coefficient calculation procedure.

FIG. 15 is a flowchart showing a fade-in point detection procedure containing a detection step S34 for detecting a fade-in point of a slow smooth change; and a detection step S35 for detecting a fade-in point of an ordinary speed change.

Firstly, in step S31, the video material to be inputted is initialized to k=j=0, fstart=j, fmode=0. After a GOP start is detected in step S32, detection of a slow (long period) fade-in point is executed in step S34 and detection of a normal (short period) fade-in point is executed in step S34. These detection steps are repeated through the processing and decision of Steps S36 and S37.

The aforementioned slow fade-in point detection of step S34 will be explained with reference to a subroutine shown in FIG. 16 and a timing chart of FIG. 17.

Here, for example, the following values are set: DC_LOW =25, DC_HIGH=70, first threshold value DELTA1=1, second threshold value DELTA2=10, constant k1=0.8, constant k2=1.0, RATE_UP=3.0, and BR_DELTA=50.

In the timing chart of FIG. 17, FIG. 17A shows a DC change of an average luminance level, and FIG. 17B shows a change of the average DC value AVR-DC of a GOP. In this FIG. 17B, the DC_LOW and the DC_HIGH are indicated by broken lines. Moreover, FIG. 17C shows a change of the B picture and I picture ration b_rate (shown as B/I in the figure) of the GOP. Moreover, FIG. 17D shows a mode change on GOP basis.

In this fade-in interval which rises slowly, a difference between GOPs is small and accordingly, the value of b_rate does not change drastically as shown in FIG. 17C. Consequently, in this case, without using the b-rate as shown in FIG. 17C, the avr_dc value as shown in FIG. 17B alone is used for detecting the aforementioned fade-in interval.

Firstly, in step S41 of FIG. 16, it is determined whether two adjacent GOPs have the avr_dc values equal to or below the DC_LOW. If both of the values are equal to or below the DC_LOW, control is passed to step S42 where fmode=1 is set and the GOP number (j) at this position is set as the fade-in point fstart=j.

Moreover, in step S43, it is determined whether a change amount from the avr_dc of the preceding adjacent GOP is equal to or below the first threshold value DELTA1 which has been set in advance. If equal to or below DELTA1, control is passed to step S42 where fmode=1 is set and the GOP number (j) at this position is set as the fade-in point fstart=j.

Moreover, in step S44, it is determined whether a change amount from AVR_dc of he preceding adjacent GOP is between the aforementioned first threshold value DELTA1 and the second threshold value DELTA2. If so, control is passed to step S45 where fmode is set to 2.

Otherwise, fmode=1 is set, and fstart=j is set for the GOP number (j) at this position.

When fmode=2 through steps S46 and S47, it is determined whether the avr_dc is equal to or above DC_HIGH. If equal to or above avr_dc, in steps S48 and S49, the weighting coefficient rate_ctl[i] of the GOPs from fstart to that position is obtained as avr_gop_genbit/gop_genbit[i]*k1. The size of the weighting coefficient rate_ctl[i] is limited to a range of 1.0 to RATE_UP by the steps S50 to S53.

These processes are repeated by steps 54 and S55. When the j-th GOP is reached, fmode=1 is set in step S56 and control is passed to step S35 of FIG. 15.

In this slow fade-in detection shown in FIG. 16, the weighting coefficient rate_ctl, if initialized to 1, is as shown in step S49, a value of ratio between the GOP difficulty and the average value which ratio is multiplied by the constant k1.

In a case when the weighting coefficient is set to a fixed value such as 2, the corrected difficulty becomes too large and the bit rate of an unnecessary size may be assigned. Moreover, depending on the difficulty distribution as a whole, the coefficient 2 may not be sufficient.

To cope with this, the weighting coefficient is determined by the video encoding method according to the present invention, so that the corrected rate is in the vicinity of the average bit rate, eliminating a case of correcting the rate too small or too large.

Next, detection of a normal fade-in point of step S35 in FIG. 15 will be explained with reference to a subroutine shown in FIG. 18 and a timing chart shown in FIG. 19.

Here, for example, the following values are set: DC_LOW=25, DC_HIGH=70, first threshold value DELTA1=−5, second threshold value DELTA2=10, constant k1=0.8, constant k2=1.0, RATE_UP=3.0, and BR_DELTA=50.

In the timing chart of FIG. 19, FIG. 19A shows a DC change of the average luminance level and FIG. 19B shows the average value AVR_DC change of the GOP DC values. In this FIG. 19B, the DC_LOW and DC_HIGH are indicated by broken lines. Moreover, FIG. 19C shows a change of the B picture and I picture ratio b-rate (shown as B/I in the figure) of the GOP.

In this fade in interval which rises at a normal speed, a difference in images between adjacent GOPs is large. In a black still image having avr_dc below DC_LOW as shown in FIG. 19B, there is no motion and the frame correlation is extremely large, which in turn extremely decreases the gen-bit of the P and B pictures. Consequently, as shown in FIG. 19C, the b-rate value becomes very small. Moreover, in the fade-in interval, because a preceding I picture and following P and B pictures have different DC levels, the frame correlation becomes small and the gen bit values of the P and B pictures become relatively large. Consequently, the b-rate value becomes very large. For this, the fade-in interval can be determined by the b_rate change amount shown in FIG. 19C and the avr_dc value shown in FIG. 19B.

Firstly, in step S61, it is determined whether a difference between the b_rate of a current GOP and the b_rate of the preceding and adjacent GOP is greater than the BR threshold value BR_DELTA and whether the preceding GOP has avr_dc equal to or below DC_LOW. If Yes, the weighting coefficient rate_ctl of the GOP interval from that position is obtained via the step S62 in step S63 as rate_ctl[i]=avr_gop_genbit/gop_genbit[i]*k2.

The size of the weighting coefficient is limited in the range of 1.0 to RATE_UP by the steps S64 to S67. Through the processing and decision of steps S68 and S69, the aforementioned coefficient is calculated for an interval from the fade-in point to a third GOP.

Next, FIG. 20 is a flowchart showing a fade-out point detection procedure containing a step S74 for detecting a slow fade-out point and step 76 for detecting a normal speed fade-out point.

Firstly, in step S71, the video material to be inputted is set to k kend, j gop_pcnt, fstart=j, and i_flag fmode=0. When a GOP start is detected in step S72, “j” is viewed from temporally back side, and detection of a slow fade-out point is executed in step S74, and detection of a normal speed fade-out point is executed in step S75. These detection steps are repeated through the following processing and decision of steps S76 and S77.

Explanation will be given on the aforementioned detection of a slow fade-out point in step S74 with reference to a subroutine shown in FIG. 21 and a timing chart shown in FIG. 22.

Here, for example, the following values are set: DC_LOW =25, DC_HIGH=70, first threshold value DELTA1=−5, second threshold value DELTA2=10, constant k1=0.8, constant k2=1.0, RATE_UP=3.0, and BR_DELTA=50.

In the timing chart of FIG. 22, FIG. 22A shows a DC change of the average luminance level, and FIG. 22B shows a change of the average value AVR_DC of the GOP DC values. In this FIG. 22B, the DC_LOW and DC_HIGH are indicated by broken lines. Moreover, FIG. 22C shows the B picture and I picture ratio b_rate of the GOP (shown as B/I in the figure). Moreover, FIG. 22D shows the fmode change on GOP basis.

In the fade-out interval which is slowly lowered, a difference in the images between adjacent GOPs is small and the b-rate value does not change abruptly as shown in FIG. 22C. In this case, without using the b-rate as shown in FIG. 22C, only the avr_dc change as shown in FIG. 22B is used for detecting the aforementioned fade-out interval.

Firstly, in step S81, search is started at a GOP which comes temporally later and it is determined whether two adjacent GOPs, i.e., a current GOP and a following GOP have avr_dc values which are both equal to or below the DC_LOW. If both are equal to or below the DC_LOW, control is passed to step S82 where fmode=1 is set for the current GOP, and the GOP number (j) at this position is set to fstart=j.

Moreover, in step S83, it is determined whether a change amount from the avr_dc of the following GOP is equal to or below the first threshold value DELTA1 which has been set in advance. If yes, control is passed to step S82 where fmode=1 is set, and the GOP number (j) at this position is set to fstart=h.

Moreover, in step S84, it is determined whether a change amount from the avr_dc of the following GOP is between the aforementioned first threshold value DELTA1 and the second threshold value DELTA2. If yes, control is passed to step S85 where fmode is set to 2.

Otherwise, fmode=1 is set, and fstart=j is set for the GOP number (j) at this position.

When fmode is through the steps S86 and S87, it is determined whether avr_dc is equal to or above the DC-HIGH. If yes, through the steps S88 and S89, the weighting coefficient rate_ctl[i] from the fstart to that position is obtained as avr_gop_genbit/gop_genbit[i]*k1. The size of the weighting coefficient is limited in the range of 1.0 to RATE_UP by the steps S90 to S93.

These processes are repeated through the steps S94 and S95. When the j-th GOP is reached, fmode=1 is set in step S96, and control is passed to step S75 of FIG. 20.

In this slow fade-out point detection shown in FIG. 21, the weighting coefficient rate_ctl, if initialized to 1, as shown in step S89, is a value of ratio between GOP_based difficulty and the average value which ratio is multiplied by the constant k1.

If the weighting coefficient is set to a fixed value such as 2, the difficulty corrected becomes too large and there arises a possibility that an unnecessary size of bit rate is assigned. Moreover, depending on the difficulty distribution as a whole, the coefficient 2 may not be sufficient.

To cope with this, the video encoding method according to the present invention determines the weighting coefficient so that the rate assigned according to a corrected value is in the vicinity of the average bit rate, which eliminates correcting the rate too small or too large.

Next, the detection of a normal speed fade-out point in step S85 of FIG. 20 will be explained with reference to a subroutine of FIG. 23 and a timing chart of FIG. 24.

Here, for example, the following values are set: DC_LOW=25, DC HIGH=70, first threshold value DELTA1=-5, second threshold value DELTA2=10, constant k1=0.8, constant k2=1.0, RATE_UP=3.0, and BR_DELTA=50.

In the timing chart of FIG. 24, FIG. 24A shows a DC change of the average luminance level, and FIG. 24B shows a change of the average AVR_DC of the GOP DC values. In this FIG. 24B, the DC-LOW and DC_HIGH are indicated by broken lines. Moreover, FIG. 24C shows a change of B picture and I picture ratio b-rate(shows as B/I in the figure) of the GOP. Moreover, FIG. 24D shows the fmode change on GOP basis.

In the case of fade-out which is lowered at such a normal speed, unlike in the fade-in interval, the b-rate change amount shown in FIG. 24C is not so large at the fade-out point and accordingly, its detection is difficult if by using the same method as the fade-in detection.

To cope with this, firstly, a fade-in position is detected from the avr_dc value shown in FIG. 24B and the b_rate change amount shown in FIG. 24C, and a position temporally nearest to the fade-in position and having the avr_dc change amount in FIG. 24B equal to or above the second threshold value DELTA2 is detected as a fade-out point.

Firstly, in step S101 of FIG. 23, it is determined whether a difference between the b-rate of a current GOP and the b-rate of a following and adjacent GOP is greater than the BR threshold value BR-DELTA and whether the current GOP has avr_dc value equal to or below the DC_LOW. If Yes, the position is set as a fade-in position and control is passed to step S102 where i-flag=1 is set.

In step S103, it is determined whether a change amount from the avr_dc of the following GOP of i_flag=1 is greater than the second threshold value DELTA2. If Yes, control is passed to steps S104 and S105 for determining the position as the fade-out point, and the GOP weighting coefficient rate_ctl is obtained as rate_ctl[i]=avr_gop_genbit/gop_genbit[i]*k2.

The size of the weighting coefficient is limited in the range of 1.0 to RATE_UP by the steps S106 to S109. Through the processing and decision of steps S110 and S111, the weighting coefficient of an interval from the fade-out point back to the third GOP from the last is calculated.

Thus, with the step S22 for the fade-in point detection and the weighting coefficient calculation and step S23 for the fade-out point detection and the weighting coefficient calculation, as has been described with reference to the aforementioned FIG. 15 to FIG. 24, after each of the weighting coefficient calculation, the respective coefficients are used in step S24 for weighting the difficulty.

FIG. 25 is a subroutine for this difficulty weighting. Firstly, in step S121, k=j=0 is set and in step S122 it is determined whether gop_start[k] has become 1 for detecting a GOP head.

In steps S12 and S124, gop_genbit obtained by tentative encoding is weighted by each of the aforementioned weighting coefficients rate_ctl, so as to calculate difficulty. In steps S125 and S126, this calculation is repeated, and the processing is terminated if it is determined via a step S127 in step S128 that the processing of last frame is complete.

After this, control is passed to step S16 of the aforementioned FIG. 12 and according to the corrected coding difficulty obtained in step S24 of the aforementioned FIG. 14, the target bit amount is calculated, so as to secure that assignment of the entire bit rate without making the bit rate too small.

It should be noted that a recording medium containing a compressed video signal recorded by the aforementioned video encoding method in which an interval where bright/dark change occurs via a dark portion is detected according to an average luminance level change within the frame, the difficulty in the aforementioned interval is corrected, and the bit amount assignment is determined according to the corrected difficulty. Consequently, the image quality will not be deteriorated even at a fade-in/fade-out point.

Moreover, in the video transmission method for transmitting the video information encoded by the aforementioned video encoding method through a cable line for example, instead of recording the information on a recording medium, an interface of bright/dark change via a dark portion is detected according to a temporal change of an average luminance in a video encoding group unit consisting of at least one intra-frame coded picture, frame-to-frame forward predictive coded pictures, and bidirectional predictive coded pictures, and the aforementioned coding difficulty in this interval is corrected, so that according to the corrected coding difficulty, the aforementioned bit assignment amount is determined. Consequently, the information can be transmitted without deteriorating the image quality at fade-in/fade-out points.

The video encoding method and apparatus according to the present invention, in an encoding system for accumulating a compressed video signal on a package medium such as a DVD for example, enable to detect a fade-in/fade-out point from the encoding material and execute weighting, so that during a rate assignment a greater rate is assigned than for a normal processing, thus enabling to improve the image quality at fade-in/fade out points.

Moreover, the recording medium according to the present invention is capable of reproducing a video data containing a fade-in/fade out without causing a sense of deterioration of the image quality.

Furthermore, the video transmission method according to the present invention is capable of receiving and reproducing a video data containing a fade-in/fade-out without causing a sense of deterioration of the image quality.

What is claimed is:

1. A video encoding method which determines a bit assignment amount according to a coding difficulty of a video frame, wherein
an interval of bright/dark change via a dark portion is detected according to a temporal change of an average luminance level within the frame, and said coding difficulty for this interval is corrected, so that said bit assignment amount is determined according to the corrected coding difficulty.

2. A video encoding method as claimed in claim 1, wherein for said interval of bright/dark change, said coding difficulty is multiplied by a weighting coefficient so as to obtain a corrected coding difficulty.

3. A video encoding method as claimed in claim 2, wherein said interval of bright/dark change contains a slow change corresponding to several video blocks each consisting of a plurality of video frames.

4. A video encoding apparatus which determines a bit assignment amount according to a coding difficulty of a video frame, said apparatus comprising:
calculation means for detecting an interval of bright/dark change via a dark portion is detected according to a temporal change of an average luminance level within the frame, and correcting said coding difficulty for this interval, so that said bit assignment amount is determined according to the corrected coding difficulty.

5. A video encoding apparatus as claimed in claim 4, wherein for said interval of bright/dark change, said calculation means multiplies said coding difficulty by a weighting coefficient so as to obtain a corrected coding difficulty.

6. A video encoding apparatus as claimed in claim 4, wherein said interval of bright/dark change contains a slow change corresponding to several video blocks each consisting of a plurality of video frames.

7. A recording medium containing a video data recorded with a bit amount assigned according to a coding difficulty of a video frame, wherein
an interval of bright/dark change via a dark portion is detected according to a temporal change of an average luminance level within the frame, and said coding difficulty for this interval of bright/dark change is corrected, so that said assignment amount is determined according to the corrected coding difficulty.

8. A video transmission method which determines a bit assignment amount according to a coding difficulty of a video frame and transmits an encoded video, wherein
an interval of bright/dark change via a dark portion is detected according to a temporal change of an average luminance level within the frame, and said coding difficulty for this interval is corrected, so that said assignment amount is determined according to the corrected coding difficulty.

9. A video encoding method which determines a bit assignment amount according to a coding difficulty of a video frame, wherein
an interval of bright/dark change via a dark portion is detected according to a temporal change of an average luminance on a video encoding group basis consisting of at least one intra-frame coded picture, a frame-to-frame forward predictive coded picture, and a bidirectional coded picture and said coding difficulty for this interval is corrected, so that said assignment amount is determined according to the corrected coding difficulty.

10. A video encoding method as claimed in claim 9, wherein for said interval of bright/dark change, said coding difficulty is multiplied by a weighting coefficient so as to obtain a corrected coding difficulty.

11. A video encoding method as claimed in claim 9, wherein a value of said weighting coefficient is calculated according to a ratio between a sum of coding difficulties of said video coding group to be processed and an average value of sum of coding difficulties of the entire video coding group.

12. A video encoding method as claimed in claim 9, wherein said interval of bright/dark change is a time duration which is several times longer than a time length of said video coding group unit.

13. A video encoding apparatus in which a bit assignment amount is determined according to a coding difficulty of a video frame, said apparatus comprising calculation means which detects an interval of bright/dark change via a dark portion according to a temporal change of an average luminance on a video encoding group basis consisting of at least one intra-frame coded picture, a frame-to-frame forward predictive coded picture, and a bidirectional coded picture and corrects said coding difficulty for this interval, so that said assignment amount is determined according to the corrected coding difficulty.

14. A video encoding apparatus as claimed in claim 13, wherein for said interval of bright/dark change, said calculating means multiplies said coding difficulty by a weighting coefficient so as to obtain a corrected coding difficulty.

15. A video encoding apparatus as claimed in claim 13, wherein said calculating means calculates a value of said weighting coefficient according to a ratio between a sum of coding difficulties of said video coding group to be processed and an average value of sum of coding difficulties of the entire video coding group.

16. A video encoding apparatus as claimed in claim 13, wherein said interval of bright/dark change is a time duration which is several times longer than a time length of said video coding group unit.

17. A recording medium containing a video data of a bit amount assigned according to a coding difficulty of a video frame, wherein
an interval of bright/dark change via a dark portion is detected according to a temporal change of an average luminance on a video encoding group basis consisting of at least one intra-frame coded picture, a frame-to-frame forward predictive coded picture, and a bidirectional coded picture and said coding difficulty is corrected for this interval, so that said assignment amount is determined according to the corrected coding difficulty.

18. A video transmission method in which a bit assignment amount is determined according to a coding difficulty of a video frame, wherein
an interval of bright/dark change via a dark portion is detected according to a temporal change of an average luminance on a video encoding group basis consisting of at least one intra-frame coded picture, a frame-to-frame forward predictive coded picture, and a bidirectional coded picture and said coding difficulty is corrected for this interval, so that said assignment amount is determined according to the corrected coding difficulty.

19. A video encoding method which determines a bit assignment amount according to a coding difficulty of a video frame, wherein
an interval of bright/dark change via a dark portion is detected according to a temporal change of an average luminance on a video encoding group basis consisting of at least one intra-frame coded picture, a frame-to-frame forward predictive coded picture, and a bidirectional coded picture and according to a temporal change of ratio of coding difficulty of a particular picture, and said coding difficulty for this interval is corrected, so that said assignment amount is determined according to the corrected coding difficulty.

20. A video encoding method as claimed in claim 19, wherein for said interval of bright/dark change, said coding difficulty is multiplied by a weighting coefficient so as to obtain a corrected coding difficulty.

21. A video encoding method as claimed in claim 19, wherein a value of said weighting coefficient is calculated according to a ratio between a sum of coding difficulties of said video coding group to be processed and an average value of sum of coding difficulties of the entire video coding group.

22. A video encoding method as claimed in claim 19, wherein said interval of bright/dark change is a time duration which is shorter than several times of a time length of said video coding group unit.

23. A video encoding apparatus which determines a bit assignment amount according to a coding difficulty of a video frame,
said apparatus comprising calculating means which detects an interval of bright/dark change via a dark portion is detected according to a temporal change of an average luminance on a video encoding group basis consisting of at least one intra-frame coded picture, a frame-to-frame forward predictive coded picture, and a bidirectional coded picture and according to a temporal change of ratio of coding difficulty of a particular picture, and which calculating means corrects said coding difficulty for this interval, so that said assignment amount is determined according to the corrected coding difficulty.

24. A video encoding apparatus as claimed in claim 23, wherein for said interval of bright/dark change, said calculating means multiplies said coding difficulty by a weighting coefficient so as to obtain a corrected coding difficulty.

25. A video encoding apparatus as claimed in claim 23, wherein said calculating means calculates a value of said weighting coefficient according to a ratio between a sum of coding difficulties of said video coding group to be processed and an average value of sum of coding difficulties of the entire video coding group.

26. A video encoding apparatus as claimed in claim 23, wherein said interval of bright/dark change is a time duration which is shorter than several times of a time length of said video coding group unit.

27. A recording medium containing a video data of a bit amount assigned according to a coding difficulty of a video frame, wherein
an interval of bright/dark change via a dark portion is detected according to a temporal change of an average luminance on a video encoding group basis consisting of at least one intra-frame coded picture, a frame-to-frame forward predictive coded picture, and a bidirectional coded picture and according to a temporal change of ratio of coding difficulty of a particular picture, and said coding difficulty for this interval is corrected, so that said assignment amount is determined according to the corrected coding difficulty.

28. A video transmission method for transmitting a coded video data in which a bit amount is assigned according to a coding difficulty of a video frame, wherein
an interval of bright/dark change via a dark portion is detected according to a temporal change of an average luminance on a video encoding group basis consisting of at least one intra-frame coded picture, a frame-to-frame forward predictive coded picture, and a bidirectional coded picture and according to a temporal change of ratio of coding difficulty of a particular picture, and said coding difficulty for this interval is corrected, so that said assignment amount is determined according to the corrected coding difficulty.
